(19) United States
(12) Patent Application Publication
(10) Pub. No.: US 2023/0356302 A1
(43) Pub. Date: Nov. 9, 2023

(54) MULTI-FIDELITY APPROACH TO MODELING OF MOLTEN DROPLET COALESCENCE IN ADDITIVE MANUFACTURING

(71) Applicant: Palo Alto Research Center Incorporated, Palo Alto, CA (US)

(72) Inventors: Giovanna Bucci, Santa Clara, CA (US); Svyatoslav Korneev, San Jose, CA (US); Adrian Lew, Stanford, CA (US); Morad Behandish, San Mateo, CA (US)

(21) Appl. No.: 17/662,092

(22) Filed: May 5, 2022

(51) Int. Cl. B22F 10/80; G05B 19/4099; B33Y 50/00

(52) U.S. Cl. CPC B22F 10/80; G05B 19/4099; B33Y 50/00; G05B 2219/35134; G05B 2219/31103

(57) ABSTRACT

Techniques for calibrating a high fidelity (HF) model of molten droplet coalescence are disclosed. An example method includes selecting initial HF parameter values for the HF model. The method also includes iteratively refining the HF parameter values until the HF model converges with experimental data. At each iteration, the HF parameter values are applied to the HF model and a plurality of simulations are run using the HF model to generate the simulated numerical data. For each simulation, a Reduced Order Model (ROM) is fitted to the simulated numerical data to generate ROM parameter values for ROM parameters of the ROM. Correlations between the ROM parameters and the HF parameters are identified to narrow the search space to be searched in a next iteration.

### TECHNICAL FIELD

Implementations of the present disclosure relate to techniques for simulating the output of a 3D printer, and more specifically to calibrating a model used for such simulation.

### BACKGROUND

Additive manufacturing (often known as 3D printing) enables production of structures that optimize strength to weight ratios. For example, hollow structures that are expensive or difficult to achieve in machining processes (i.e., removal of materials by cutting) may be created layer by layer in additive manufacturing. Many forms of additive manufacturing make use of transforming matters from one state to another, such as from liquid to solid, by chemical reactions or by heat (e.g., melting materials at specific locations and solidifying when cooled).

Depending on the type of 3D printing technology, the output of a 3D printing process may be highly dependent on a variety of factors, such as the material used, the temperature of the material, the physical characteristics of the 3D printer, and others. Many of these factors may be controlled by controlling various settings of the 3D printer. However, it may take several iterations of the 3D printing process to obtain setting adjustments that provide the desired results. Accordingly, it may be useful in some cases to be able to simulate the output of the 3D printer. If several print iterations can be performed in a digital simulation, the user can more quickly determine suitable 3D printer settings for a particular print job, thereby saving time and material that would otherwise be wasted. The ability to simulate the results of a 3D print job depend on having a model that accurately describes the physics of the 3D printing process.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments. Like numerals indicate like elements

FIG. 1 illustrates a block diagram of a 3D printing system, in accordance with certain aspects of the present disclosure.

FIG. 2 is a graph of the experimental data that describes droplet aspect ratio over time, in accordance with certain aspects of the present disclosure.

FIG. 3 is a graph of example target ROM parameter values for a particular experimental setup, in accordance with certain aspects of the present disclosure.

FIG. 4 is a graph of example simulated data that describes droplet aspect ratio over time, in accordance with certain aspects of the present disclosure.

FIG. 5 is a scatter plot of selected parameter data for a single iteration of the HF model calibration process, in accordance with certain aspects of the present disclosure.

FIG. 6 is a scatter plot of selected parameter data for a single iteration of the HF model calibration process, in accordance with certain aspects of the present disclosure.

FIG. 7 is a scatter plot of selected parameter data for a single iteration of the HF model calibration process, in accordance with certain aspects of the present disclosure.

FIG. 8 is a scatter plot of selected parameter data for a single iteration of the HF model calibration process, in accordance with certain aspects of the present disclosure.

FIG. 9 is a correlation table showing the strength of the correlations between various HF model parameters and ROM parameters, in accordance with certain aspects of the present disclosure.

FIG. 10 is bar graph showing the distribution of values for a ROM parameter, in accordance with certain aspects of the present disclosure.

FIG. 11 is bar graph showing the distribution of values for another ROM parameter, in accordance with certain aspects of the present disclosure.

FIG. 12 illustrates a process flow diagram for a method of calibrating a HF model, in accordance with certain aspects of the present disclosure.

FIG. 13 illustrates an example computational device for performing operations of HF model calibration, in accordance with certain aspects of the present disclosure.

### DETAILED DESCRIPTION

Aspects of the present disclosure provides various techniques for calibrating a simulation model used to simulate the output of a 3D printing process. The techniques disclosed herein are applicable to 3D printing processes that use inkjet technology. In inkjet 3D printing, a liquid material, such as a molten metal, can be ejected from a nozzle and deposited onto a substrate. In such techniques, a single molten droplet deposited on a solid of the same material serves as the basic building block for fabrication by precise, dropwise deposition.

Simulation of such 3D printing techniques can be performed using multi-physics models, also referred to herein as high-fidelity (HF) models, that capture the deposition process at the mesoscopic or continuum scale. High fidelity models describe the behavior of a build material based on the physics of the 3D printing process and the physical characteristics and behaviors of the build materials. For example, a high fidelity model may take into account material temperature, material ejection speed, the temperature of the substrate (e.g., the 3D object being printed), the viscosity of the build material, and many other factors. The high fidelity model may also include a model of the behavior of individually deposited molten droplets, i.e., a high-fidelity model of molten droplet coalescence.

Such high-fidelity models can be calibrated for the specific build material and specific experimental conditions to ensure accuracy. One manner of calibrating a high fidelity model is to measure experimental data for a 3D printer and adjust the values of the model parameters until the model simulation results converge with the measured experimental data. However, an accurate high fidelity model for modeling molten droplet coalescence may include several parameters, for example, 10 to 20 parameters or more. This creates a very high dimensional parameter space in which to search for a solution. Repeatedly solving coupled multi-physical equations to sample such a high dimensional parameter space tends to be expensive for high-fidelity models. Optimization of the model parameters is often unfeasible because of the high computation cost of each solution.

In accordance with the present techniques, a multi-fidelity technique is used to accelerate the calibration of a high-fidelity model of molten droplet coalescence in the context of additive manufacturing. The multi-fidelity technique described herein can be used to more efficiently search the parameter space of the high fidelity model and more quickly converge upon an optimal or near-optimal solution to the high fidelity model calibration. To search the parameter space more efficiently, a reduced order model (ROM) is used to supply the trend toward the general vicinity of the high-fidelity model optimum.

The reduced order model is a function that can be used to accurately model the molten droplet coalescence using fewer parameters. The same ROM can be used to represent the experimental data and to provide a simple representation of the simulation results of the high-fidelity model. The correlations between HF model parameters and the ROM model parameters can be used as a criterion to select the most relevant HF model parameters that control droplet dynamics in the particular experimental setup under study. Target ROM parameters can be derived by fitting the ROM to the experimental data. The target ROM parameters and correlations between the ROM parameters and the HF parameters can then be used as a guide for determining an effective search space for the HF parameters. In this way, the dimension of the sampled parameter space can be reduced, and the range of values can be progressively narrowed.

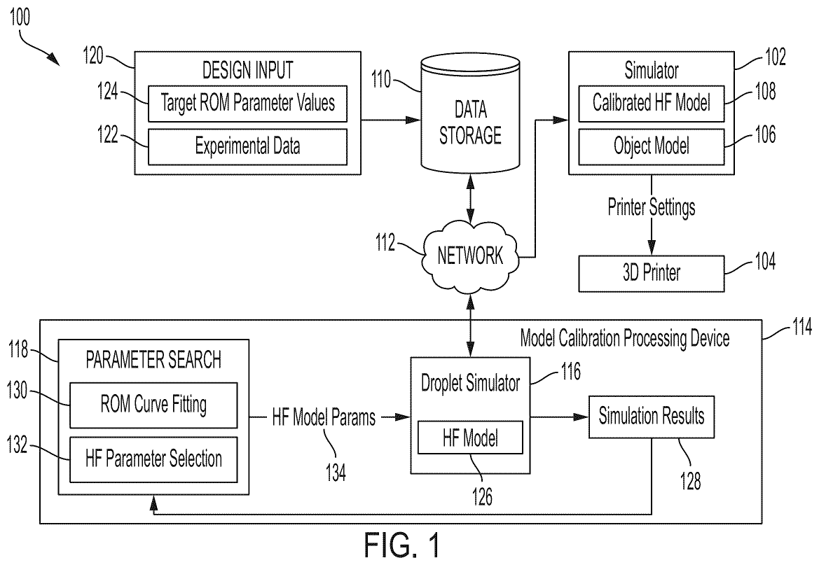

FIG. 1 illustrates a block diagram of a 3D printing system, in accordance with certain aspects of the present disclosure. The system 100 can include a simulator 102 that is configured to simulate the output of an actual 3D printer 104. The simulator 102 can receive an object model 106 describing a 3D object to be printed, and use a calibrated HF model 108 to generate a virtual object, i.e., a digital representation of the 3D object that would be printed by the 3D printer 104. The simulator 102 may be connected to a data storage device 110 through a network 112. The data storage device 110 may store various data such as object models 106 and user information, which can be accessed by the simulator 102. The 3D printer 104 may be an inkjet printer or other type of printer that ejects molten droplets.

The simulator 102 may have settings that are adjustable by the user and represent actual settings of the actual 3D printer 104. Each of the printer settings also relates in some way to one or more parameters of the calibrated HF model 108. Accordingly, the user can adjust the printer settings virtually and the effect of the printer settings in the real world can be simulated by affecting corresponding changes to the calibrated HF model 108. In this way, different printer settings can result in a different virtual object. The virtual object generated by the simulator 102 may be represented as a 3D image that can be presented to the user in a graphical user interface.

The virtual object is generated by the simulator 102 using the calibrated HF model 108, the object model 106, and the printer settings as input. The simulator 102 is intended to simulate the actual physical product that would be produced by the actual 3D printer 104 if the same object model 106 and printer settings were supplied as input to the actual 3D printing process. In this way, any flaws or undesirable characteristics can be identified in the virtual object without the need to run an actual print job. Additionally, the printer settings can be adjusted by the user to determine the most suitable printer settings for a particular print job. Once the user is satisfied with the quality of the virtual object, the printer settings can be transferred to the actual 3D printer 104 and used for the printing the actual 3D object.

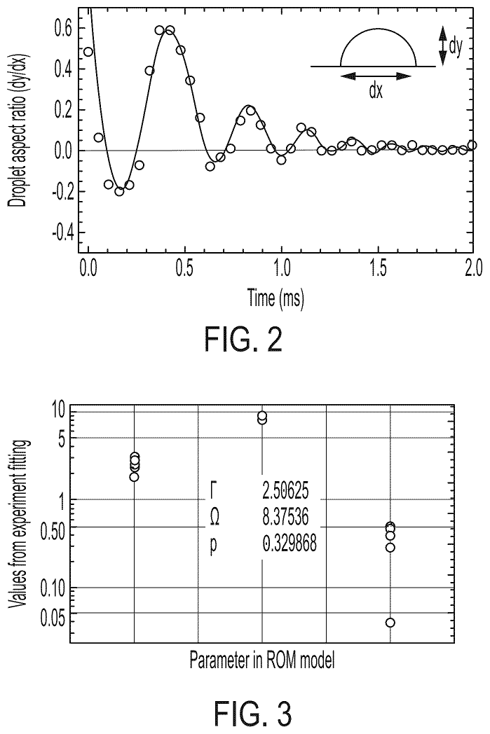

The degree of agreement between the virtual object and the actual printed object will depend, at least in part, on the accuracy of the calibrated HF model 108. The calibrated HF model 108 may be generated by a model calibration processing device 114, which also has access to the data storage device 110 through the network 112. The calibration process may be performed using experimental data 122 acquired by the user of the 3D printer. For example, the experimental data may include measurements performed in relation to an actual print job run by the 3D printer to be calibrated or a similar 3D printer. In some embodiments, the experimental data describes droplet aspect ratio over time, as example of which is shown in FIG. 2. The experimental data may be obtained, for example, through video camera imaging of a droplet.

As a part of the calibration process, the ROM may be fitted to the experimental data by iteratively adjusting the ROM parameter values until a suitable match is obtained between the experimental data and a curve represented by the parameterized ROM. The parameter values of the fitted ROM may be used as target ROM parameter values, which may be used to guide the parameter search for the HF model 126.

The model calibration processing device 114 includes a droplet simulator 116, and a parameter search module 118. The model calibration processing device 114 is configured to search the parameter space of the HF model 126 to identify HF model parameter values that cause the simulation results 128 provided by the droplet simulator 126 to converge with the experimental data 122. The droplet simulator 116 uses the HF model 126 to simulate the physical droplet dynamics, e.g., the droplet aspect ratio over time. The simulation results 128 include numerical data that describes the same type of physical droplet dynamics, e.g., droplet aspect ratio over time. The particular simulation results provided will depend on the particular parameter value settings of the HF model 126. In some examples, several parameter value sets may be provided so that a search of the relevant parameter space can be performed.

The simulation results 128 may be sent to the parameter search module 118 to identify new HF model parameter values in the parameter search space. The identification of new HF parameter settings may be guided by the ROM. For example, the ROM may be curve fitted to the numerical data of the simulation results. The HF model parameters may then be evaluated to identify particular HF model parameters that are strongly correlated with the ROM parameters. These strongly correlated HF model parameters will be expected to have a stronger effect on causing the HF model to converge with the experimental results. Those HF model parameters that are strongly correlated with the ROM parameters may be adjusted for the next iteration of the droplet simulator, while those parameters that are not strongly correlated with the ROM parameters can remain constant, thereby reducing the parameter search space that is to be explored.

Additionally, the ROM can also be used to identify the particular search space to be explored for each of the strongly correlated HF model parameters. This can be accomplished because the target ROM parameters 124 have already been determined by fitting the ROM parameters to the experimental data 122. Accordingly, for a specific HF parameter that is strongly correlated with a specific ROM parameter, a range of values close to the target value of that ROM parameter can be selected as next search targets. In this way, convergence between the HF model 126 and the experimental results can be obtained more quickly compared to a random search or even a gradient-based search.

The result of the parameter search module 118 is several sets of new HF model parameter values 134, wherein each set of new HF model parameter values results in a different simulation result. In other words, each parameter value set includes a single value for each of the HF parameters. Several parameters value sets can be generated in order to provide a more thorough search of the particular parameter space being investigated. The droplet simulator 116 can run a number simulations using these new HF model parameter values 134, resulting in additional simulation results, and the process can be repeated until the HF model 126 converges with the experimental data, i.e., the simulation results provided by the HF model 126 match the experimental data 122 within a specified threshold. One convergence is achieved, the resulting HF model 126 may be stored as the calibrated HF model 108. Additional details of the calibration process are described in relation to FIGS. 2-8.

In some embodiments, the calibrated HF model 108 may be specific to an individual 3D printer and/or combination of 3D printer and build material. In such cases, the calibration process may be provided as a service to customers who own 3D printers. For example, the user may place an order for a calibrated HF model 108 and upload experimental data 122 measured for their own 3D printer 104 operating with a particular build material. In response, the user can receive the calibrated HF model 108 and begin performing simulations. In some examples, the simulator may also be provided as a service.

In some embodiments, the calibrated HF model 108 may be applicable to a specific type of printer, for example, a specific brand and/or specific 3D printer version. In such cases, the calibrated HF model 108 may be broadly applicable to a type of 3D printer or a combination of a specific type of 3D printer and a specific type of build material. In such cases, the experimental data may be gathered and the calibration process performed by the manufacturer or other third party such as developer of the simulator software. The calibrated HF model 108 can then be provided to users or used by the simulator 102 in cases in which simulator itself is provided as a service.

FIG. 2 is a graph of the experimental data that describes droplet aspect ratio over time, in accordance with certain aspects of the present disclosure. In FIG. 2, the droplet aspect ratio is the height of the drop divided by the width of the drop after making contact with the substrate. As used herein, the substrate refers to the surface of the partial 3D object that is being built up by the ejection of the build material. Time zero represents the time at which the drop first makes contact with the substrate. As shown in FIG. 2, the aspect ratio of the droplet oscillates over time after it impacts the substrate. Various factors will affect the final spread of the droplet after solidification, including the oscillation damping time and the solidification time. Droplet spread and oscillation, and the timescale for droplet solidification are important design parameters that affect the quality of the printed part and reliability of the printing process.

Each point represents a measurement of the droplet at a specific time after impact with the substrate. The measurements may be performed, for example, using time lapse imaging and subsequent quantification of the droplet image results. The curve represents a ROM curve obtained by fitting the ROM to the experimental data. Fitting the ROM to the curve means identifying the ROM parameter values that cause the curve to closely approximate the experimental data. The ROM parameters values may be obtained using any suitable optimization algorithm.

The ROM may be one of several possible forms depending on the specific implementation. In some embodiments, the ROM is derived from a damped-harmonic oscillator model that accurately predicts the droplet oscillation after the impact with the substrate. For example, the ROM may be characterized by the following equation, which describes a 6-parameter ROM:

e^{-Γt}(α·cos(tΩe^{pt}+Φ)+f) Eq. 1

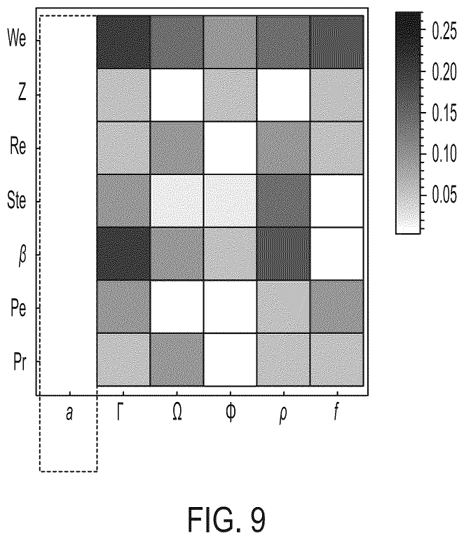

In the above equation, Γ is the damping coefficient, α is the amplitude, Ω is the angular frequency of the droplet oscillation, p describes the evolution of the angular frequency over time, Φ is the phase constant, f is the equilibrium position, and t represents time. The damping pre-factor e^{-Γt} affects both the amplitude of the oscillation and the equilibrium position over time. In some embodiments, Γ, α, Ω, p, Φ, and f are all parameters of the ROM that are to be optimized for fitting the ROM to the experimental data (or the simulated numerical data as describe in relation to FIG. 3.) As described further below in reference to FIGS. 9-11, equation 1 can be simplified to the following form:

e^{-Γt}(cos(tΩe^{pt}+C₁)+C₂) Eq. 2

In the above equation, Φ and f are replaced by constants C₁ and C₂ and are therefore not adjusted during the optimization process. Accordingly, the ROM of equation 2 is a 3-parameter ROM. By reducing the number of parameters, the process of fitting the ROM to the data can be accomplished faster and with less processing overhead.

FIG. 3 is a graph of example target ROM parameter values for a particular experimental setup, in accordance with certain aspects of the present disclosure. In this example, the ROM is the three-parameter ROM of equation 2. Accordingly, there are three target ROM parameters shown in FIG. 3, namely Γ, Ω, p. In some embodiments, the experimental data may include several sets of experiments, wherein each experiments results in a set of data similar to that shown in FIG. 2. For each experiment, the ROM may be fit to the experimental data to obtain a different set of ROM parameters. Accordingly, each point shown in FIG. 3 represents a specific value of a specific ROM parameter for each time that the ROM was fitted to the data of a specific experiment. These ROM parameter values may be averaged to determine the target ROM parameter values. Optionally, outliers may be discarded before averaging. In the example shown in FIG. 3, the target ROM parameter values are Γ=2.5, Ω=8.38, and p=0.33, approximately.

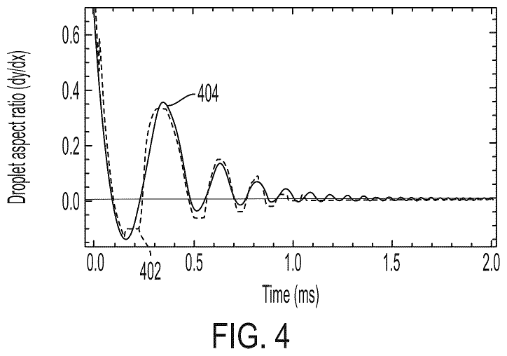

FIG. 4 is a graph of example simulated data that describes droplet aspect ratio over time, in accordance with certain aspects of the present disclosure. With reference to FIG. 1, the simulated data may be generated by the droplet simulator 116 using the HF model 126. In FIG. 4, curve 402 represents the simulated data, and curve 404 represents the curve generated by the ROM (e.g., the 3-parameter ROM) after the ROM is fitted to the simulated data.

The HF model may include any of several parameters that relate to the actual physics of droplet oscillation. In some embodiments, the HF model is characterized using the following system of incompressible Navier-Stokes equations for multiphase flow:

$$\{ \begin{matrix}∇ \cdot u = 0 \\ \frac{\partial ( {ρ}_{k} {α}_{k} u )}{\partial t} + {ρ}_{k} {α}_{k} u \cdot ∇ ) u = - ∇ p + ∇ \cdot ( {μ}_{k} {α}_{k} ∇ u ) + {F}^{D} + σκ ∇ {α}_{liquid}\end{matrix}$$

with the subscript k={solid, liquid, vapor} indicating the phase. The artificial momentum sink FD shown below may be introduced to describe the loss of momentum associated with solidification, and it contains the tunable parameters C, ϵ.

$${F}^{D} = - C \frac{{α}_{solid}^{2}}{{( 1 - {α}_{solid} )}^{2} + ε} u$$

The system of equations describing the conservation of the mass and momentum of the fluid can be coupled with the following equation describing the conservation of the mass fraction:

$$\frac{\partial {α}_{k}}{\partial t} + u \cdot ∇ {α}_{k} - {S}_{k}$$

where S is a term representing generation/loss of the mass fraction due to the phase change. For example, when liquid is solidified, S is negative for the liquid phase and positive for the solid phase.

The function that describes the change in mass fraction can have the general form:

S_{liquid}=−S_{solid}=f(Tₛ,Tₗ,Cₗₑₑ,α_{liquid},α_{solid})

The HF model can also include the heat transfer equation:

$$\frac{\partial h}{\partial t} + u \cdot ∇ h = ∇ \cdot ( {λ}_{k} ∇ T )$$

where λₖ is the heat conductivity coefficient of phase k; T is the temperature and h is the enthalpy per unit volume, defined as h=Σₖαₖ∫c_{p,k}(T)dT+α_{liquid}L.

In the above equations, the variable u is a flow velocity vector, p is the fluid density, a is the phase fraction function with the constraint that the sum of all phase fractions is equal to Σₖαₖ=1, p is the pressure, μ is the dynamic viscosity, σ is the surface tension, Cₗₑₑ is the model constant representing solidification time scale, Tₛ is the solidus temperature and Tₗ is the liquidus temperature. The initial and boundary conditions include the initial droplet velocity at ejection u₀, the droplet radius at ejection r₀, the droplet temperature at ejection T_{d}, and the substrate temperature before the droplet impact T_{sub}.

The number of independent parameters of the HF model can be reduced by defining a set of non-dimensionless parameters, including the Weber number We, the Stephan number Ste, the Peclet number Pₑ, and the Reynolds number Rₑ. The Weber number and Stephan number may be defined by the following equations:

$$We = \frac{ρ {u}_{0}^{2} {r}_{0}}{σ}$$

$$Ste = \frac{{c}_{p} ( {T}_{s} - {T}_{sub} )}{L}$$

where cₚ is the specific heat capacity at constant pressure, and L is the latent heat associated with the phase change.

Other HF model parameters that may affect the physics of droplet oscillation and the final spread of the molten droplet include the following:

$$z = \frac{μ}{\sqrt{ρσ {r}_{0}}} Ohnesorge number$$

$$β = \frac{{T}_{d} - {T}_{s}}{{T}_{s} - {T}_{sub}} melt superheat parameter$$

$$Pr = \frac{v}{{r}_{0}} Prandtl number ( v is a kinematic viscosity )$$

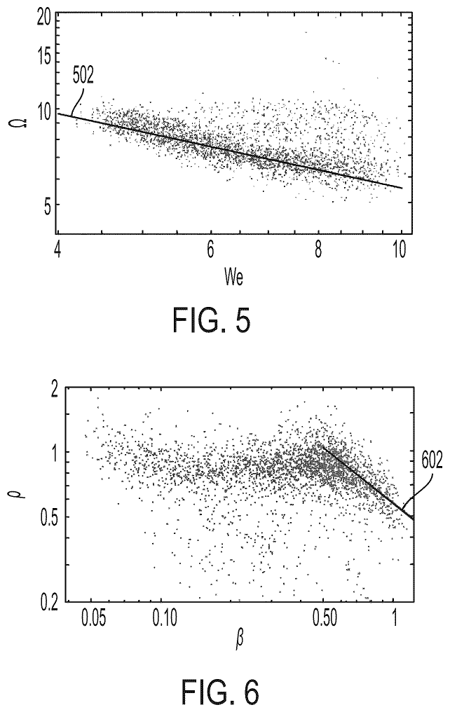

The HF model may be varied to incorporate any of the above parameters. Curve 402 represents the simulated droplet behavior for a single point in the HF parameter search space, i.e., a single set of the HF model parameter values. Curve 404 represents the ROM for a single point in the ROM parameter search space, i.e., a single set of the ROM parameter values. For each iteration of the HF model calibration process, several points in the HF parameter space may be searched, resulting in several curves 402. Additionally, the ROM may be fitted to each of these simulated curves. The resulting HF parameter data and ROM parameter data may be used to facilitate further searching of the HF parameter space as described further in relation to FIGS. 5-8.

FIG. 5 is a scatter plot of selected parameter data for a single iteration of the HF model calibration process, in accordance with certain aspects of the present disclosure. Each dot in the graph corresponds with a single simulation and single set of numerical data describing the droplet oscillation for that simulation. The placement of the dot on the X-axis represents the value of the Weber number, We, that was used in the simulation, and the placement of the dot on the Y-axis represents the value of Ω that was arrived at (for example, by the ROM curve fitting module 132 of FIG. 1) in fitting the ROM to the numerical data for that particular simulation. The linear grouping of these data points indicates whether there is a strong correlation between the particular HF model parameter and the particular ROM parameter. In this particular data set, the linear grouping of points shown by the trend line 502 indicates that there is a strong correlation between the Weber number, We, and Ω such that variation of the Weber number would be expected to be more influential on the outcome of the simulation than other HF parameters that do not appear to be strongly correlated with one of the ROM parameters.

FIG. 6 is another scatter plot of selected parameter data for a single iteration of the HF model calibration process, in accordance with certain aspects of the present disclosure. As in FIG. 5, each dot in the graph corresponds with a single simulation and single set of numerical data describing the droplet oscillation for that simulation. However, in this example, the placement of the dot on the X-axis represents the value of the melt superheat parameter, β, used in the simulation, and the placement of the dot on the Y-axis represents the value of p that was arrived at in fitting the ROM to the numerical data for that particular simulation. The linear grouping of the points for values of between 0.5 and 1.0 as shown by the trend line 602 indicates that there is a strong correlation between and p.

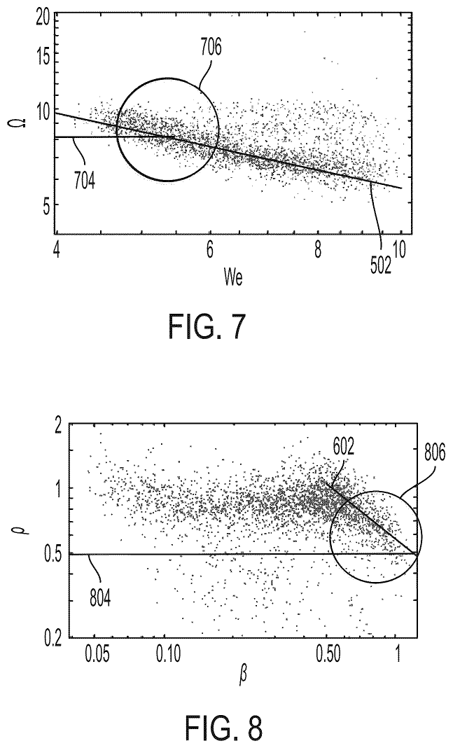

Graphs like the one shown in FIGS. 5 and 6 may be generated for each combination of HF model parameter and ROM parameter. Based on data shown in these graphs, the HF parameter selection module 132 may rank the HF model parameters in order from highly correlated to weakly correlated. A specified number of the most highly ranked HF model parameters may selected for further searching in the next iteration of the droplet simulator. In other words, the HF parameters for the next iteration may be generated by creating parameter value sets wherein the highly ranked parameters are varied while the remaining parameters remain set to a single specific value. In some embodiments, the specific values to be searched will be based at least in part on the target ROM parameter values as described in relation to FIGS. 7 and 8.

FIG. 7 is the same scatter plot shown in FIG. 5. The trend line 502 represents the approximately linear relationship between the We and Ω, and the horizontal line 704 represents the target ROM parameter value for Ω. This target ROM parameter is also shown in FIG. 3. Since it has been determined that the target value for Ω causes the ROM to closely match the experimental data, it is also likely that the Weber number values in the same vicinity of the target value for Ω will cause the HF model to more closely match the experimental data. Accordingly, the search space of the Weber number can be limited to a small range of values near the intersection of trend line 502 and line 704 as indicated the circle 706.

FIG. 8 is the same scatter plot shown in FIG. 6. The trend line 602 represents the approximately linear relationship between the β and p within a certain range of values, and the horizontal line 804 represents the target ROM parameter value for p. This target ROM parameter is also shown in FIG. 3. As shown in FIG. 8, the search space of β can be limited to a small range of values near the intersection of line 602 and line 804 as indicated the circle 806.

It will be appreciated the graphs shown in FIGS. 5-8 are to illustrate the machine processes being performed and are not meant to indicate that the model calibration device generates a visual display of the data to be shown to a user. Rather, the data represented by the graph may be represented in a digital form and processed automatically (i.e., without human involvement) to identify the relevant parameter search space and HF model parameters.

FIG. 9 is a correlation table showing the strength of the correlations between various HF model parameters and ROM parameters, in accordance with certain aspects of the present disclosure. In FIG. 9, the HF model parameters are shown in rows, and the ROM parameters from Eq. 1 are shown in columns. For the sake of clarity, a small number of the possible HF model parameters are shown. However, it will be appreciated that the same process can be performed using any suitable number of HF model parameters.

The color at the intersection of an HF model parameter and a ROM parameter indicates the strength of the correlation between the two parameters, with the darker color indicating a stronger correlation. The correlation strength may be computed as a confidence interval, for example. It can be seen from this table, that the ROM parameter, α, does not have a strong correlation with any of the displayed HF model parameters. This indicates that α does not have a significant effect on fitting the ROM model to the experimental data or the simulated numerical data. Accordingly, the ROM parameter, α, can be eliminated from the ROM model as shown in Equation 2, resulting in a simplification of the ROM model and fewer parameters to be adjusted when fitting the ROM model to the experimental data or the simulated numerical data. By simplifying the ROM model, the HF model calibration can be performed more quickly and with fewer processing resources.

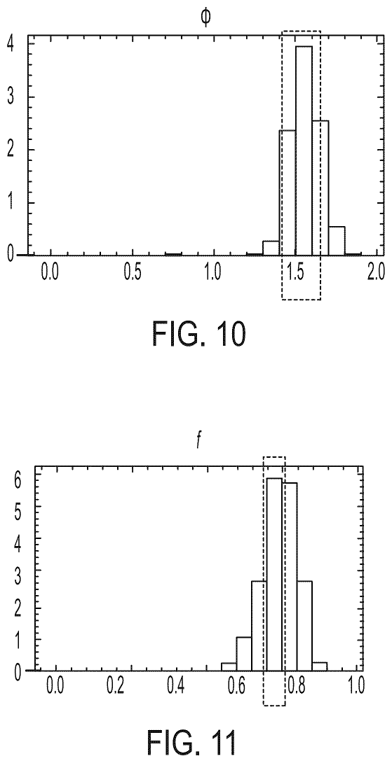

FIG. 10 is a bar graph showing the distribution of values for the ROM parameter Φ, in accordance with certain aspects of the present disclosure. The distribution of values may be based on the collection of values arrived at when fitting the ROM to the experimental data and/or the simulated numerical data. Additionally, the collection of values may relate to a single simulation or several simulations. As shown in FIG. 10, the values of Φ are distributed over a narrow range, between about 1.4 and 1.7. This suggests that there is a narrow range of valid values for this particular ROM parameter. Accordingly, the ROM parameter Φ can be replaced by the constant, C₁, as shown in Equation 2, wherein C₁ is set to the average value of Φ in the distribution. In this example, C₁ may be set to 1.5.

FIG. 11 is bar graph showing the distribution of values for the ROM parameter f, in accordance with certain aspects of the present disclosure. The distribution of values may be based on the collection of values arrived at when fitting the ROM to the experimental data and/or the simulated numerical data. As shown in FIG. 11, the values of f are distributed over a narrow range, between about 0.65 and 0.85. Accordingly, the ROM parameter f can be replaced by the constant, C₂, as shown in Equation 2, wherein C₂ is set to the average value of f in the distribution. In this example, C₂ may be set to 0.72.

Replacing adjustable ROM parameters with constants as described in relation to FIGS. 10 and 11 provides for additional simplification of the ROM model, which reduces the applicable search space when fitting the ROM model to the experimental data or the simulated numerical data and enables the HF model calibration to be performed more quickly and with fewer processing resources. The simplifications described in FIGS. 9-11 may be used to reduce the original 6-parameter ROM of Equation 1 to the 3-parameter ROM of Equation 2.

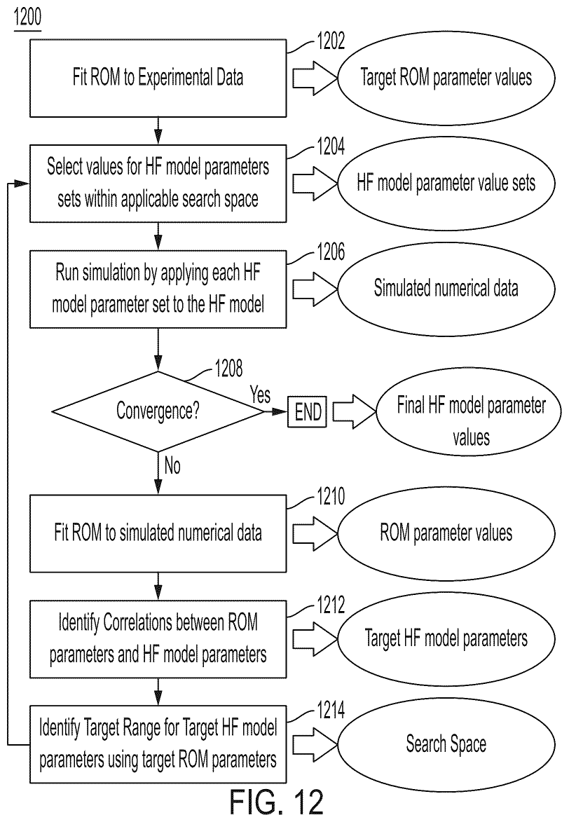

FIG. 12 illustrates a process flow diagram for a method of calibrating a HF model, in accordance with certain aspects of the present disclosure. The method may be performed by a computing device such as the model calibration processing device 114 shown in FIG. 1. The method may begin at block 1202.

At block 1202, a ROM is fitted to a selection of experimental data. The experimental data may be submitted by the user and may be received from a storage device or over a network. The experimental data may be measured data that describes droplet characteristics (e.g., droplet aspect ratio) at discrete times after the droplet is ejected from a 3D printer onto a substrate. The experimental data may include several sets of experimental data, wherein a single set refers to the several measurements performed over time for a single ejected drop. The method 1200 may be performed using a single set of experimental data or several sets of experimental data.

The ROM may be any suitable ROM selected for the calibration process, including a 3-parameter ROM, 4-parameter ROM, 5-parameter ROM, 6-parameter ROM, or others. An example of a ROM fitted to a single set of experimental data is shown in FIG. 2. At block 1202, a different set of ROM parameter values is derived for each set of experimental data, wherein a single set of ROM parameter values refers to the values for each adjustable parameter of the ROM that define a single curve. FIG. 3 shows five sets of ROM parameter values derived by fitting the ROM individually to five different sets of experimental data. The ROM parameter values derived at block 1202 may be averaged together to obtain target ROM parameter values.

At block 1204, values are selected for the HF model parameters within the applicable search space. The search space is defined by the particular HF parameters that are to be adjusted and the range of values over which the values can be selected. A coarse sampling of the search space will be performed on the first iteration of the method. The selection of the HF model parameter values results in HF model parameter value sets, wherein each set describes the value of each HF parameter used in a particular simulation.

At block 1206, simulations are run by applying each HF model parameter value set to the HF model. Each simulation uses a single HF parameter value set and results in a corresponding set of numerical data. Each set of simulated numerical data describes the simulated droplet characteristics (e.g., droplet aspect ratio) over time, and is comparable to the measured experimental data.

At block 1208, the simulated numerical data can be compared to the experimental to determine if the HF model and the experimental data have converged. Convergence can be determined, for example, by computing a difference between the experimental data and each set of simulated numerical data and comparing the differences to a threshold. If one of the sets of simulated numerical data is within the threshold, then the process can end and the corresponding HF model parameter values can be identified as the final HF model parameter values for the calibrated HF model. The final HF model parameter values may be stored for future use, delivered to a user, or incorporated into a simulation software, for example. If the HF model and the experimental data have not converged, then the process continues to block 1210 so that the search space can be narrowed.

At block 1210, the ROM is fitted to each set of simulated numerical data. The ROM used at block 1210 is the same ROM used at block 1202, meaning that the form of the model is the same while the values of the parameters will generally be different for each fitted ROM. The result of block 1210 is a set of ROM parameter values, wherein each set describes the parameter values used to fit a single curve to particular set of numerical data. FIG. 4 shows an example of a single set of simulated numerical data for a particular simulation and a curve generated by fitting the ROM to the numerical data.

At block 1212, the ROM parameter values generated at block 1210 and the HF model parameter values generated at block 1204 are compared to identify correlations between individual parameters. A strong correlation between a HF model parameter and a ROM parameter indicates that the identified HF parameter may be influential for adjusting the HF model to achieve convergence, whereas a weak correlation may indicate the HF model parameter is not influential. The identification of correlations between HF model parameters and ROM parameters is described further in relation to FIGS. 5 and 6. In some embodiments, the strength of correlation between each HF model parameter and each ROM parameter may be computed and ranked. A selection of the highest ranked HF parameters (e.g., top two, top three, etc.) may be selected as target HF parameters. The target HF parameter are those parameters to be adjusted for the next iteration of the method.

At block 1214, the target range for each target HF model parameter is identified. The target range for each target HF model parameter may be identified by selecting a range of HF model parameter values that correspond with the target ROM parameter value of the correlated ROM parameter, as shown for example in FIGS. 7 and 8. The target HF parameters and the target ranges for each target HF model parameter define the new search space for the next iteration. The process flow then returns to block 1204, and new values are selected for each of the HF model parameters. During the selection of new values only the target HF model parameters are adjusted, and the remaining HF model parameters remain constant for each parameter value set. Additionally, the values selected for the target HF model parameters are selected to be within the target range.

Various operations are described as multiple discrete operations, in turn, in a manner that is most helpful in understanding the present disclosure, however, the order of description may not be construed to imply that these operations are necessarily order dependent. In particular, these operations need not be performed in the order of presentation.

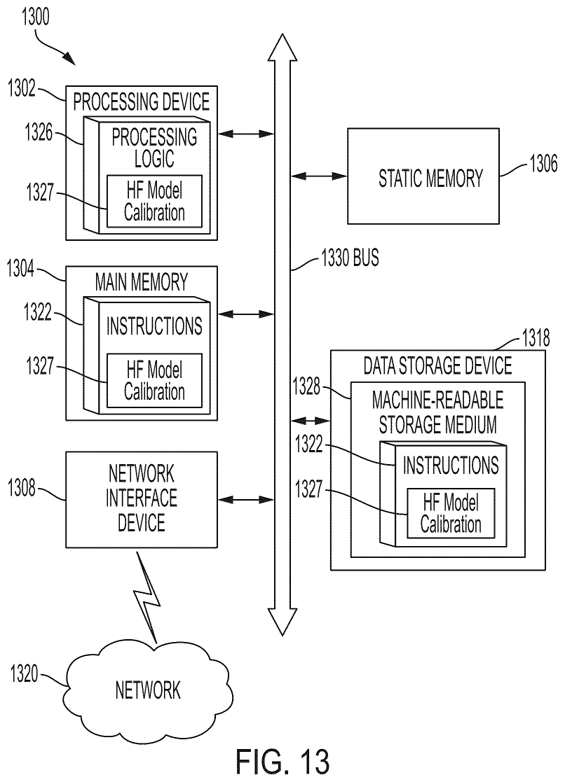

FIG. 13 illustrates a diagrammatic representation of a machine in the example form of a computer system 1300 within which a set of instructions 1322 and/or processing logic 1326, for causing the machine to perform any one or more of the methodologies discussed herein, may be executed. For example, the instructions 1322 and processing logic 1326 may include a High-Fidelity Model Calibration algorithm 1327 in accordance with the techniques described herein. In various embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 1300 may be representative of a server computer system, such as system 100.

The exemplary computer system 1300 includes a processing device 1302, a main memory 1304 (e.g., read-only memory (ROM), flash memory, dynamic random access memory (DRAM), a static memory 1306 (e.g., flash memory, static random access memory (SRAM), etc.), and a data storage device 1318, which communicate with each other via a bus 1330. The processing device 1302 may be implemented as the model calibration processing device 114 of FIG. 1 or a related processing device unit, a system processing device (e.g., including the computational layer 150), or both. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 1302 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1302 may also be one or more special-purpose processing devices such as an application specific integrated circuit (ASIC), a field programmable gate array (FPGA), a digital signal processor (DSP), network processor, or the like. The processing device 1302 may execute processing logic 1326, which may be one example of system 100 shown in FIG. 1, for performing the operations and steps discussed herein.

The data storage device 1318 may include a machine-readable storage medium 1328, on which is stored one or more set of instructions 1322 (e.g., software) embodying any one or more of the methodologies of functions described herein, including instructions to cause the processing device 1302 to execute system 100. The instructions 1322 may also reside, completely or at least partially, within the main memory 1304 or within the processing device 1302 during execution thereof by the computer system 1300; the main memory 1304 and the processing device 1302 also constituting machine-readable storage media. The instructions 1322 may further be transmitted or received over a network 1320 via the network interface device 1308.

The non-transitory machine-readable storage medium 1328 may also be used to store instructions 1322 to perform the methods and operations described herein. While the machine-readable storage medium 1328 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof.

What is claimed is:

1. A method of calibrating a high fidelity (HF) model of molten droplet coalescence, comprising:
obtaining experimental data that describes behavior of a droplet ejected from a 3D printer;
selecting initial HF parameter values for HF parameters of an HF model; and
iteratively refining the HF parameter values until the HF model converges with the experimental data, wherein each iteration comprises:
applying the HF parameter values to the HF model and running a plurality of simulations using the HF model to generate the simulated numerical data for each simulation;
for each simulation, fitting a Reduced Order Model (ROM) to the simulated numerical data generated by the simulation to generate ROM parameter values for ROM parameters of the ROM; and
identifying, by a processing device, correlations between the ROM parameters and the HF parameters and narrowing a search space to be searched in a next iteration based on the correlations.

2. The method of claim 1, wherein the HF model is used to generate simulated numerical data that describes a simulated droplet aspect ratio over time.

3. The method of claim 1, wherein the ROM is a three-parameter damped-harmonic oscillator model, and the ROM parameters comprise dumping coefficient Γ, angular frequency Ω, and p describing time evolution of the angular frequency.

4. The method of claim 1, wherein identifying correlations between the ROM parameters and the HF parameters comprises, for a selected ROM parameter and a selected HF parameter, generating a scatter plot of the ROM parameter values and the HF parameter values, and identifying a correlation between the selected ROM parameter and the selected HF parameter based on groupings and curve fittings between the ROM parameter values and the HF parameter values.

5. The method of claim 1, wherein identifying correlations between the ROM parameters and the HF parameters comprises computing a correlation strength for selected combinations of the ROM parameters and the HF parameters, wherein the method further comprises ranking the correlations based on the correlation strength.

6. The method of claim 5, wherein narrowing the search space to be searched in a next iteration comprises selecting a specified number of top ranked correlations, and identifying the HF model parameters for those correlations as target HF parameters to be adjusted for the next iteration.

7. The method of claim 1, further comprising fitting the ROM to the experimental data to identify target values of the ROM parameters that cause the ROM to approximate the experimental data.

8. The method of claim 7, wherein narrowing the search space to be searched in a next iteration comprises:
identifying, for a specific HF parameters of the HF parameters, a correlated ROM parameter; and
identifying a range of values for the specific HF parameter that produces similar simulation results compared to the target value of the correlated ROM parameter.

9. The method of claim 1, further comprising, after the HF model converges with the experimental data, storing the HF parameter values as final HF parameter values for a calibrated HF model, wherein the calibrated HF model is used to generate digital simulations of a 3D object created by a virtual 3D printer based on a digital model of the 3D object.

10. The method of claim 9, wherein one or more settings of an actual 3D printer are adjusted based on the digital simulations and used for printing the 3D object on the actual 3D printer.

11. An apparatus for calibrating a high fidelity (HF) model of molten droplet coalescence for a 3D print simulator, the apparatus comprising:
a memory to store experimental data that describes behavior of a droplet ejected from a 3D printer;
a processing device operatively coupled to the memory, wherein the processing device is to:
select initial HF parameter values for HF parameters of an HF model; and
iteratively refine the HF parameter values until the HF model converges with the experimental data, wherein at each iteration the processing device is to:
apply the HF parameter values to the HF model and run a plurality of simulations using the HF model to generate the simulated numerical data for each simulation;
for each simulation, fit a Reduced Order Model (ROM) to the simulated numerical data generated by the simulation to generate ROM parameter values for ROM parameters of the ROM; and
identify correlations between the ROM parameters and the HF parameters and narrow a search space to be searched in a next iteration based on the correlations.

12. The apparatus of claim 11, wherein the HF model is used to generate simulated numerical data that describes a simulated droplet aspect ratio over time.

13. The apparatus of claim 11, wherein:
to identify the correlations, the processing device is to compute a correlation strength for selected combinations of the ROM parameters and the HF parameters; and
to narrow the search space, the processing device is to rank the correlations based on the correlation strength to select a specified number of top ranked correlations, and identify the HF model parameters for those correlations as target HF parameters to be adjusted for the next iteration.

14. The apparatus of claim 11, wherein the processing device is further to:
fit the ROM to the experimental data to identify target values of the ROM parameters that cause the ROM to approximate the experimental data; and
to narrow the search space, identifying, for a specific HF parameters of the HF parameters, a correlated ROM parameter, and
identify a range of values for the specific HF parameter that produces similar simulation results compared to the target value of the correlated ROM parameter

15. The apparatus of claim 11, wherein the processing device is further to:
after the HF model converges with the experimental data, store the HF parameter values as final HF parameter values for a calibrated HF model;
generate digital simulations of a 3D object created by a virtual 3D printer based on the calibrated HF model and a digital model of the 3D object;
adjust one or more settings of an actual 3D printer based on the digital simulations.

16. A non-transitory computer-readable storage medium having instructions stored thereon that, when executed by a processing device for calibrating a high fidelity (HF) model, cause the processing device to:
obtain experimental data that describes behavior of a droplet ejected from a 3D printer, wherein the experimental data describes a measured droplet aspect ratio over time;
select initial HF parameter values for HF parameters of an HF model; and
iteratively refine the HF parameter values until the HF model converges with the experimental data, wherein at each iteration the processing device is to:
apply the HF parameter values to the HF model and run a plurality of simulations using the HF model to generate the simulated numerical data;
for each simulation, fit a Reduced Order Model (ROM) to the simulated numerical data generated by the simulation to generate ROM parameter values for ROM parameters of the ROM; and
identify correlations between the ROM parameters and the HF parameters and narrow a search space to be searched in a next iteration based on the correlations.

17. The non-transitory computer-readable storage medium of claim 16, wherein the HF model is used to generate simulated numerical data that describes a simulated droplet aspect ratio over time.

18. The non-transitory computer-readable storage medium of claim 16, wherein:
to identify the correlations, the processing device is to compute a correlation strength for selected combinations of the ROM parameters and the HF parameters; and
to narrow the search space, the processing device is to rank the correlations based on the correlation strength to select a specified number of top ranked correlations, and identify the HF model parameters for those correlations as target HF parameters to be adjusted for the next iteration.

19. The non-transitory computer-readable storage medium of claim 16, wherein the processing device is further to:
fit the ROM to the experimental data to identify target values of the ROM parameters that cause the ROM to approximate the experimental data; and
to narrow the search space, identifying, for a specific HF parameters of the HF parameters, a correlated ROM parameter, and
identify a range of values for the specific HF parameter that produces similar simulation results compared to the target value of the correlated ROM parameter

20. The non-transitory computer-readable storage medium of claim 16, wherein the processing device is further to:
after the HF model converges with the experimental data, store the HF parameter values as final HF parameter values for a calibrated HF model;
generate digital simulations of a 3D object created by a virtual 3D printer based on the calibrated HF model and a digital model of the 3D object; and
adjust one or more settings of an actual 3D printer based on the digital simulations.
